(19) United States
(12) Patent Application Publication
(10) Pub. No.: US 2015/0001385 A1
(43) Pub. Date: Jan. 1, 2015

(54) MEMORY EFFECT TRACER FLUIDS FOR THE STUDY OF AN OIL RESERVOIR

(71) Applicants: Pascal Perriat, Lyon (FR); Nicolas Crowther, Saint-Quentin-Fallavier (FR); Matteo Martini, Lyon (FR); Olivier Tillement, Fontaines Saint Martin (FR); Thomas Brichart, Lyon (FR); Nicolas Agenet, Pau (FR)

(72) Inventors: Pascal Perriat, Lyon (FR); Nicolas Crowther, Saint-Quentin-Fallavier (FR); Matteo Martini, Lyon (FR); Olivier Tillement, Fontaines Saint Martin (FR); Thomas Brichart, Lyon (FR); Nicolas Agenet, Pau (FR)

(73) Assignee: TOTAL SA, Courbevoie (FR)

(21) Appl. No.: 14/128,323

(22) PCT Filed: Jun. 22, 2012
(86) PCT No.: PCT/EP2012/062084

§ 371 Date: Aug. 28, 2014

(30) Foreign Application Priority Data
Jun. 22, 2011 (FR) 11 55515

(51) Int. Cl. G01V 8/02; G01N 21/64

(52) U.S. Cl. CPC G01V 8/02; G01N 21/64; G01N 2021/6497
USPC 250/259; 252/301.16

(57) ABSTRACT

The fluid tracers according to the invention have the advantage of producing a memory effect fluorescent signal, that is to say a signal modified as a function of the physico-chemical conditions encountered in the medium through which the nanoparticles pass after injection into the geological underground area. The analysis of fluorescent signals in the fluids collected after diffusion makes it possible to deduce therefrom information on the characteristics of the oil reservoir.

### PRIORITY CLAIM

The present application is a National Phase entry of PCT Application No. PCT/EP2012/062084, filed Jun. 22, 2012, which claims priority from French Patent Application No. 11 55515, filed Jun. 22, 2011, said applications being hereby incorporated by reference herein in their entirety.

### FIELD OF THE INVENTION

The field of this invention is that of exploration and exploitation of oil reservoirs. More precisely, this invention relates to the development of nanoparticles and tracer fluids containing them, intended to be injected into a well, and collected by reversal of the fluid flow through the same well.

### TECHNOLOGICAL BACKGROUND OF THE INVENTION

It is well known in the prior art to use of tracers in order to obtain information on an oil reservoir or more generally on a resource of an underground geological area, a reservoir of hydrocarbon, water, gas, oil or petroleum. Techniques using for example tracers with different partition coefficients have been described. The principle is founded in particular on chromatography. One of the tracers interacts more specifically with certain fluids contained in the rock, for example oil, and diffusion thereof will be slowed down in the presence of oil. By quantification of the diffusion time lag with respect to a tracer which interacts a little or not at all with its environment (surreptitious tracer), the quantity of oil contained in the reservoir is deduced therefrom.

These methods of analysis can be conducted based on only one well (“Single Well Tracer Test”) or two wells, comprising an injection well and a production well.

With regard to the prior art relating to such tracers for injection waters (tracing fluid) enabling surveying of the oil reservoirs by diffusion between an injection well and a production well, reference may be made to the patents U.S. Pat. No. 4,231,426 B1 and U.S. Pat. No. 4,299,709 B1 which disclose aqueous tracer fluids comprising from 0.01 to 10% by weight of a nitrate salt associated with a bactericidal agent.

The patent U.S. Pat. No. 3,623,842 describes a method of measurement an oil saturation in the vicinity of a well (“Single Well Tracer Test”) consisting of injecting a first partitioning tracer (water/oil) which releases a surreptitious tracer after a certain period of diffusion in the porous medium.

The site of “Institute for Energy Technology” (IFE) has put online a PowerPoint presentation entitled SIP 2007-2009 “New functional tracers based on nanotechnology and radiotracer generators Department for Reservoir and Exploration Technology” (last modification dated 7 Mar. 2011). In particular, this document suggests the use of surface-modified nanoparticles as tracer for monitoring flows in oil reservoirs and oil wells and in studies of processes. Even more precisely, this presentation also describes functionalised tracers capable of emitting a signal modulated as a function of the physico-chemical conditions through which it passes.

In a quite different field, the French Patent Application FR 28 67 180 A1 describes hybrid nanoparticles comprising, in the one hand, a core consisting of a rare earth oxide, possibly doped with a rare earth or an actinide or a mixture of rare earths and actinide and, on the other hand, a coating around this core, the said coating consisting predominantly of polysiloxane functionalised by at least one biological ligand grafted by covalent bond. The core may be based on Gd₂O₃ doped with Tb³⁺ or by uranium and the coating of polysiloxane can be obtained by causing an aminopropyltriethoxysilane, a tetraethylsilicate and triethylamine to react.

These nanoparticles are used as probes for the detection, the tracking and the quantification of biological systems.

Moreover, there are about ten families of appropriate molecules currently validated as tracer for injection waters in oil reservoirs. These families of molecules are for example fluorinated benzoic acids or naphthalenesulphonic acids.

It is also known that the fluorescent objects often have a fluorescence closely linked to the physico-chemical conditions encountered with a very wide possible variation of their emission spectra, their excitation spectra, their emission lifetime or their quantum yields.

For example, certain compounds exhibit an emission or an emission lifetime (fluorescence decay time) which is highly dependent upon the temperature and are thus used in remote measurement of temperature (J. Lakowicz, “Principles of fluorescence spectroscopy”, Springer 2006, page 216).

Other compounds such as fluorescein and derivatives thereof are themselves very sensitive to the pH conditions and may have an emission intensity which varies by several orders of magnitude between an acid and a base pH (N. Clonis, W. H. Sawyer, “Spectral properties of the prototropic forms of fluorescein in aqueous solution”, J. Fluorescence, 1996, 6, 147).

These variations may be irreversible or reversible as a function of the compounds. If the use of fluorescent compounds as tracer is known, the use of the modification of “irreversible” fluorescence is generally considered as a drawback for the interpretation of tracing curves and the quantifications.

The deterioration of the fluorescence signal can nevertheless give of information on the medium encountered and could be then be used as a “memory effect” signal of the conditions encountered.

In the biological field several tests of modification of fluorescence linked to memory effects have been proposed: they are in relation to the encounter with a biomolecule or a specific cell. Mention may be made for example of the Patent Application US2010/0272651. This suggests the use of fluorescent tracers in relation to indicators for the determination of particular pharmacokinetics or biodistributions within organisms.

Nevertheless, currently, the use of “memory effect” signals in the oil field has never been described nor even suggested.

In fact, the inventors had to develop novel tracers having a modified fluorescence detectable by resolved time (linked to the emission of lanthanide in particular), even in the presence a substantial background noise linked to the organic compounds present in the different oils.

### SUMMARY OF THE INVENTION

In this context the object of the present invention addresses the following objectives:
to propose a novel method of studying a solid medium, for example an oil reservoir, by diffusion of a liquid through said solid medium, which is simple to implement and economical;
to remedy the drawbacks of tracers for injection waters of oil reservoirs according to the prior art;
to provide nanoparticles having a memory effect fluorescence signal, that is to say a signal of which the emission and/or excitation spectrum is modified as a function of the physico-chemical conditions of the medium through which it passes;
to provide a novel tracer fluid comprising these nanoparticles which can be used in particular in a process for studying a solid medium, for example an oil reservoir by diffusion of said liquid through said solid medium and recovery by the same well by reversal of the flow.

These objectives, amongst others, are achieved by the invention which relates in the first place to a method of studying a geological underground area, such as an oil reservoir, by diffusion of a liquid for injection into said underground area, characterized in that it comprises the following steps:
an injection liquid is injected into the underground area to be studied, comprising nanoparticles:
   of mean diameter between 20 and 200 nm;
   capable of forming a stable colloidal suspension in a saline medium.
   of which at least a part consists of a core and, if applicable, a matrix coating the core;
   and of which the core and/or, if applicable, the matrix comprise at least a or several fluorescent entities capable of producing at least one memory effect fluorescence signal, that is to say a fluorescence signal irreversibly modified as a function of the physico-chemical conditions encountered in the underground area;
the injection liquid which has diffused is collected at different times following the injection period;
and the memory effect fluorescent signal(s) emitted by the nanoparticles as a function of time, the analysis of the memory effect fluorescent signal(s) detected making it possible to deduce therefrom information on the physico-chemical conditions of the underground geological area studied, for example of the oil reservoir.

In a preferred embodiment of the method according to the invention, at least a part of the nanoparticles comprises
at least one organic fluorophore, and,
at least one organometallic fluorophore,
the combination of two types of fluorophore being chosen in such a way that the nanoparticle produces at least one memory effect fluorescence signal.

The invention also relates to a tracer fluid which can be used in particular in the method according to the invention, and characterized in that it comprises nanoparticles:
of mean diameter between 20 and 200 nm;
capable of forming a stable colloidal suspension in a saline medium.
of which at least a part consists of a core and, if applicable, a matrix coating the core;
and of which the core and/or, if applicable, the matrix comprises at least one organic fluorophore and at least one organometallic fluorophore, the combination of the two types of fluorophores being chosen in such a way that the nanoparticle produces at least one memory effect fluorescence signal, said signal being detectable by time-resolved fluorophore.

In a specific embodiment, the nanoparticles are capable of emitting at least one memory effect fluorescence signal, and at least one fluorescence signal which is stable, that is to say which does not vary as a function of the physico-chemical conditions encountered or of which the variation is not irreversible.

### BRIEF DESCRIPTION OF THE DRAWINGS

FIG. 1 shows the emission spectra of the three solutions according to the preparation 1 brought to ambient temperature with an excitation wavelength of 330 nm (FIG. 1a), and 395 nm (FIG. 1b) measured with a time lag of 0.1 ms and an acquisition time of 5 ms.

FIG. 2 shows the emission spectra of the three solutions according to the preparation 3 brought to ambient temperature with an excitation wavelength of 285 nm (time lag 0.1 ms, acquisition time 5 ms).

FIG. 3 shows the emission spectra of the two solutions according to the preparation 2 brought to ambient temperature with an excitation wavelength of 330 nm (time lag 0.1 ms, acquisition time 5 ms).

FIG. 4 shows the emission spectra of the three solutions according to the preparation 4 brought to ambient temperature with an excitation wavelength of 285 nm (time lag 0.1 ms, acquisition time 5 ms).

FIG. 5 shows the excitation spectrum at a fixed emission for europium at 615 nm of the three solutions according to the preparation 1 at different pH values (time lag 0.1 ms, acquisition time 5 ms).

FIG. 6 shows the excitation spectrum at a fixed emission for europium at 615 nm of the two solutions of nanoparticles according to the preparation 1 in DEG and a DEG/water mixture (time lag 0.1 ms, acquisition time 5 ms).

FIG. 7 shows the excitation spectra of the three solutions of colloids prepared according to the preparation 1 brought to ambient temperature with an emission wavelength of 615 nm (time lag 0.1 ms, acquisition time 5 ms).

### DETAILED DESCRIPTION OF THE INVENTION

### Method of Studying a Geological Underground Area

The underground area studied (e.g. rocks) may be of a varied geological nature. Preferably, this involves studying an underground reservoir of hydrocarbons, and more particularly an oil reservoir. In particular it involves measuring the proportion of oil and water on the edges of a well and also characterizing the physico-chemical properties such as the pH or the redox potential.

### the Nanoparticles:

The injection fluids used in the method according to the invention comprise nanoparticles with the following characteristics:
they have a mean diameter between 20 and 200 nm;
capable of forming a stable colloidal suspension in a saline medium.
of which at least a part consists of a core and, if applicable, a matrix coating the core;
the core and/or, if applicable, the matrix comprise at least one or several fluorescent entities capable of producing at least one memory effect fluorescence signal, that is to say a fluorescence signal irreversibly modified as a function of the physico-chemical conditions encountered in the underground area.

These nanoparticles are detectable, that is to say that it is possible to identify their presence or absence in the medium above a certain concentration and that it is even possible to quantify the concentration thereof when they are present in the medium.

These nanoparticles are capable of forming a stable colloidal suspension in a saline medium which does not settle very much. For example, this suspension does not exhibit precipitation or agglomeration over time, e.g. after 6 months at ambient temperature.

According to an advantageous embodiment of this method, the core of the nanoparticles contains at least one material chosen within the group comprising: semi-conductors, the noble metals (e.g. Au, Ag, Pt), fluorides, vanadates or rare earth oxides and mixtures and/or alloys thereof; preferably a lanthanide; alloys and mixtures thereof, and, even more preferably, a lanthanide chosen within the sub-group consisting of: Pr, Nd, Sm, Eu, Tb, Dy, Ho, Er, Tm and Yb and mixtures and/or alloys thereof.

If applicable, the nanoparticles also contain a preferably transparent matrix chosen within the group of materials comprising: silicas, polysiloxanes, aluminas, zircons, aluminates, aluminophosphates, metal oxides (for example TiO₂, ZnO, CeO₂, Fe₂O₃, . . . ) and mixtures and/or alloys thereof, this matrix including within it and/or on its surface:
i. luminescent entities chosen within the group comprising: semi-conductors, oxides, rare earth fluorides or vanadates, the organic fluorescent molecules (preferably fluorescein and/or rhodamine), the transition metal ions, the rare earth ions which are or are not bound to complexing molecules and/or molecules making it possible to improve the absorption and the mixtures and/or alloys thereof,
ii. optionally other entities enabling a modification of the luminescence properties and chosen within the group comprising: particles of noble metal and mixtures and/or alloys thereof;
iii. and mixtures of these entities (i) and (ii).

The nanoparticles preferably have a matrix functionalised on the surface, that is to say which includes of radicals R grafted, preferably by covalence, preferably based on silane bonds Si—R on the surface and originating from:
i. hydrophilic compounds which may be charged, preferably hydrophilic organic compounds, molar masses below 5000 g/mol and more preferably below 450 g/mol, preferably chosen from among the organic compounds including at least one of the following functions: alcohol, carboxylic acid, amine, amide, ester, ether oxide, sulphonate, phosphonate and phosphinate, and mixtures of these hydrophilic compounds which may be charged,
ii. neutral hydrophilic compounds, preferably a polyalkylene glycol, more preferably a polyethylene glycol, Diethylene Triamine PentaAcetic acid (DTPA), dithiolated DTPA (DTDTPA) or a succinic acid, and mixtures of these neutral hydrophilic compounds,
iii. one or more hydrophobic compounds, preferably polymers;
iv. or mixtures thereof

If applicable, the matrix may comprise other materials, chosen from within the group consisting of silicas, aluminas, zircons, aluminates, aluminophosphates, metal oxides or also metals (example: Fe, Cu, Ni, Co . . . ) passivated on the surface by a layer of the oxidised metal or another oxide and mixtures and alloys thereof.

In a particular embodiment, said nanoparticles comprise:
a core consisting of a noble metal or an alloy of noble metals,
a matrix comprising (i) polysiloxanes, (ii) an organic fluorophore and (iii) an organometallic fluorophore, said fluorophores being bound covalently to the polysiloxanes, said matrix being functionalised on its surface in order to form silane bonds Si—R, wherein preferably at least 50%, preferably at least 75% of said radicals—R consist of neutral or charged hydrophilic compounds, preferably from amongst polyethers or polyols, or mixtures thereof.

Advantageously, the matrix of the nanoparticles includes radicals—R grafted at the rate of at least one radical R per 10 nm² of surface and preferably at least one per nm².

In order to monitor the interactions between, on the one hand, the solid medium to be studied, namely for example the geological underground area (e.g. rocks) containing the oil reservoir and, on the other hand, the nanoparticles, it is possible according to an advantageous arrangement of the invention to adjust the hydrophilic lipophilic balance and/or the zeta potential of the matrix of the nanoparticles as a function of the underground area to be studied.

In order to do this, for example, either the same surface charge is provided for the nanoparticles and the rocks of the solid medium, in order to create a repulsion and limit the interactions, or the respective charges are modulated so that the nanoparticles and the rocks of the solid medium interact in a controlled and/or specific manner with respect to certain rocks.

The nanoparticles according to the invention have a mean diameter preferably between 20 nm and 100 nm, for example between 20 nm and 50 nm. In an advantageous embodiment the nanoparticles according to the invention have a polydispersity index of less than 0.3, preferably less than 0.2, for example less than 0.1.

The size distribution of the nanoparticles is for example measured with the aid of a commercial granulometer such as a Malvern Zetasizer Nano-S granulometer based on PCS (Photon Correlation Spectroscopy). This distribution is characterized by a mean diameter and a polydispersity index.

Within the meaning of the invention, “mean diameter” is understood to mean the harmonic mean of the diameters of the particles. The polydispersity index makes reference to the width of the size distribution deriving from the analysis of the cumulants according to the standard ISO 13321:1996.

An essential characteristic of the study method according to the invention resides in the use of nanoparticles capable of produce a memory effect signal.

The invention relates to a memory effect fluorescent signal, a signal of which the characteristics, for example the fluorescence intensity of the emission spectrum, the excitation spectrum, the emission lifetime or the quantum yields, are modified irreversibly as a function of certain physico-chemical conditions encountered in the underground area through which it passes. Thus, the nature and/or the intensity of the alteration of the fluorescent signal makes it possible to deduce therefrom certain physico-chemical conditions of the environment through which it passes.

The physico-chemical conditions studied include for example, the temperature of the underground, the pH, the hydrocarbon content or also the redox potential of the underground area through which it passes.

In an advantageous embodiment nanoparticles will be used which comprise at least one or several fluorescent entities making it possible to produce at least one memory effect fluorescence signal and one or more fluorescent entities producing a stable signal, that is to say, contrary to the memory effect, a signal which is not irreversibly modified as a function of the physico-chemical conditions encountered. As examples of fluorescent entities producing a stable signal, mention may be made of lanthanides or other entities of which the luminescence is not sensitive to the local environment because the f orbitals used are not very available to interact with the elements present in their sphere of coordination and therefore modify their luminescence properties.

In a preferred embodiment of the invention, at least a part of the nanoparticles comprises:
i. at least one organic fluorophore, and,
ii. at least one organometallic fluorophore,
the combination of two types of fluorophore being chosen in such a way that the nanoparticle produces at least one memory effect fluorescence signal.

It is known that the fluorescence signal of certain organic fluorophores is modified irreversibly as a function of the physico-chemical conditions encountered by the tracer carrying the fluorophores, and in particular as a function of the pH, the temperature and/or the redox potential.

As an example of an organic fluorophore capable of being used, in combination with an organometallic fluorophore, in order to obtain a memory effect fluorescent signal, mention may be made of fluorescein (for example fluorescein isothiocyanate FITC), rhodamine (for example rhodamine B isothiocyanate RBITC) or other fluorescent entities which have emission spectra in the same range as fluorescein or rhodamine, for example the products with the brand names Alexa Fluor, Cy Dyes, Atto, FluoProbes.

The organometallic fluorophores of the nanoparticles are chosen from among rare earth vanadates or oxides, or mixtures thereof. In a specific embodiment they are chosen from among lanthanides, alloys thereof and mixtures thereof, bound to complexing molecules.

In a preferred embodiment the organometallic fluorophores are detectable by time-resolved fluorescence. Then lanthanides bound to complexing molecules are particularly preferred.

The metals of the lanthanide series comprise elements with atomic numbers from 57 (lanthanum) to 71 (lutetium). For example, the lanthanides will be chosen from within the group consisting of: Pr, Nd, Sm, Eu, Tb, Dy, Ho, Er, Tm and Yb and mixtures and/or alloys thereof, bound to complexing molecules, and preferably europium and terbium.

“Complexing molecules” or “chelating agent” are understood to mean any molecule capable of forming with a metallic agent a complex comprising at least two co-ordination bonds.

In a preferred embodiment, a complexing agent having a co-ordinance of at least 6, for example at least 8, and a dissociation constant of the complex pKd, greater than 10 and preferably greater than 15, with a lanthanide

Within the meaning of the invention, the “dissociation constant pKd” is understood to mean the measurement of the equilibrium between the ions complexed by the ligands and the free ligand dissociated in the solvent. Precisely, it is not so much the base 10 logarithm of the product of dissociation (−log(Kd)), defined as the equilibrium constant of the reaction which expresses the passage from the complexed state to the ionic state.

Such complexing agents are preferably polydentate chelating molecules chosen from amongst the families of molecules of the polyamine type, carboxylic polyacids and those having a high number of potential co-ordination sites preferably greater than 6, such as certain macrocycles.

In a more preferred embodiment, DOTA or 1,4,7,10-tetraazacyclododecane-1,4,7,10-tetraacetic acid of the following formula will be chosen:

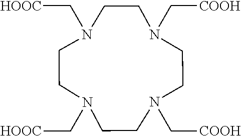 [SMILES: O=C(O)CN1CCN(CC(=O)O)CCN(CC(=O)O)CCN(CC(=O)O)CC1]

or one of the derivatives thereof.

A “cyclic agent” is understood to be an organic molecule, having at least one aromatic ring or heterocyclic ring, preferably chosen from amongst benzene, pyridine or derivatives thereof and capable of amplifying the fluorescent signal emitted by the organometallic fluorophore and/or the organic fluorophore, for example a complexing agent bound to lanthanide. These cyclic agents, which are of interest if they are characterized by a high absorbance, are used in particular to amplify the fluorescent signal emitted by the fluorophores (antenna effect by transfer of the excitation of the agent to the fluorophore).

The cyclic agent can be grafted covalently either directly to the polysiloxanes of the matrix or to the organometallic and/or organic fluorophore.

In a specific embodiment, the organometallic fluorophores consisting of a lanthanide with a complexing agent are grafted covalently to the polysiloxanes of the matrix of the nanoparticles via an amide function.

Organic fluorophore and organometallic fluorophore contained in the same nanoparticle are chosen in such a way as to produce a memory effect fluorescence signal, preferably detectable by time-resolved fluorescence.

In a more particularly preferred embodiment, the nanoparticles comprise at least one organic fluorophore chosen among fluorescein or one of the derivatives thereof and at least one organometallic fluorophore, chosen among europium (Eu) or terbium (Tb), bound to a complexing agent.

In a more particularly preferred embodiment, the nanoparticles comprise at least one organic fluorophore chosen among rhodamine or one of the derivatives thereof and at least one organometallic fluorophore, chosen among Eu or Tb, bound to a complexing agent.

In order to multiply the information on the environment studied, the injection liquid can comprise a mixture of nanoparticles, each type of nanoparticles being characterized by the emission of one or more specific fluorescence signals, and in that said signals emitted by each type of nanoparticles are detectable by multiplex detection means.

The multiplex detection makes it possible to analyses several fluorescence signals (characterized for example by different wavelengths) in parallel on the same sample. Use will also be made fluorescent entities with different emission and/or excitation wavelengths according to each type of nanoparticles.

Other signals emitted by the nanoparticles may also be detected in parallel, and for example signals detectable by analysis chemical, by ICP and/or by magnetic analysis (magnetic transition temperature, for example according to Curie or to Neel).

In order to further increase the level of information which can be collected, the injection liquid comprises at least two types of nanoparticles which are distinguished by their hydrophilic/lipophilic balance and/or their zeta potential, such that a part of the nanoparticles has a fluorescent signal delayed with respect to the other part of the nanoparticles because of their interaction with the underground area. Thus, for example, nanoparticles interacting with certain rocks of the underground area will have their memory effect signal more greatly modulated relative to the nanoparticles interacting a little or not at all with these same rocks.

Nanoparticles which can be used in the method according to the invention and the preparation thereof are presented in the Examples below.

### Methodology

In a preferred application of the method according to the invention, the injection liquid is injected and is collected in the same well (the injection well and the production well are identical) by inversion of the flow of the injected liquid.

According to a remarkable embodiment of the method according to the invention, before the analysis of the liquid which has diffused, said liquid is concentrated, preferably by filtration or dialysis, and, even more preferably, by tangential filtration and preferably by use of a membrane with cut-off thresholds below 300 kDa (kilo Dalton).

The quantity of tracer in the liquid which has diffused can be measured, by detection by fluorescence and/or by analysis chemical and/or by ICP and/or by magnetic analysis (magnetic transition temperature, for example according to Curie or to Néel).

According to a variant for the measurement of the quantity of tracer in the liquid which has diffused, at least a detection is carried out by time-resolved fluorescence, that is to say activating the detection with a time lag (e.g. several microseconds) after an excitation pulse on one or several fluorescent entities contained in the nanoparticle and capable of emitting a “stable” signal, that is to say which has not been modulated irreversibly as a function of the physico-chemical conditions encountered.

The memory effect fluorescent signal or signals are measured, preferably as a function of time after the injection, again preferably by time-resolved fluorescence. By comparison of the signal or signals obtained as a function of the time with respect to a stable signal it is possible to deduce therefrom the modification induced by the physico-chemical conditions encountered during the diffusion of the injection liquid in the vicinity of the well.

In a particular embodiment, the method of the invention makes it possible to obtain information on the temperature variations undergone by the tracer fluid in the underground area through which it passes. In another particular embodiment, the variations of pH in the traversed underground area are deduced therefrom. In another particular embodiment, the rate of exposure to certain hydrocarbons is deduced therefrom.

### Injection Liquid (Water) for the Study of a Solid Medium, Namely e.g. an Oil Reservoir

According to another of its objects, the invention relates to a liquid for injection (or a tracer fluid) in an oil reservoir which can be used in particular in the method defined above, characterized in that it comprises nanoparticles:
of mean diameter between 20 and 200 nm;
capable of forming a stable colloidal suspension in a saline medium.
of which at least a part consists of a core and, if applicable, a matrix coating the core;
and of which the core and/or, if applicable, the matrix comprises at least one organic fluorophore and at least one organometallic fluorophore, the combination of the two types of fluorophores being chosen in such a way that the nanoparticle produces at least one memory effect fluorescence signal, said signal being detectable by time-resolved fluorophore.

This liquid advantageously comprises water and nanoparticles (or a mixture of nanoparticles) as defined above.

### Use of the Nanoparticles

According to another of its objects, the invention relates to a novel use of the nanoparticles as defined above as tracers in injection waters of an oil reservoir, which are intended for the study of said reservoir by diffusion of these injection waters through said reservoir, for the purpose in particular of evaluating the volumes of oil in reserve in the reservoir.

According to another application, for example in methods of exploration or of prospecting including hydraulic fracturing, it is possible to map the temperature history of the nanoparticles after diffusion in the vicinity of an injection well then to deduce therefrom the presence of one or several of fracturing lines.

Preparation 1. Colloidal Solution of Nanoparticles with a Core of Gold and a Silica Matrix Encapsulating Organic Fluorophores Derived from Fluorescein and Europium Complexes (DTPA)

200 mg of diethylenetriaminepentaacetic acid bisanhydride (DTPABA), 0.130 mL of APTES and 0.065 mL of triethylamine are introduced with 4 mL of DMSO (dimethyl sulfoxide) into a 10 mL bottle and stirred vigorously. After 24 hours, 200 mg of EuCl₃,6H₂O are added and the mixture is stirred for 48 hours.

20 mg of FITC (fluorescein isothiocyanate) are introduced with 0.5 mL of APTES ((3-aminopropyl)triethoxysilane) into a 2.5 mL bottle and stirred vigorously. Homogenization is carried out at ambient temperature for 30 minutes. 36 mL of Triton X-100 (surfactant), 36 mL of n-hexanol (co-surfactant), 150 mL of cyclohexane (oil) and 21 mL of aqueous solution containing 9 mL of HAuCl₄.3H₂O at 16.7 mM, 9 mL of MES (sodium 2-mercaptoethanesulphonate) at 32.8 mM and 3 mL of NaBH₄ at 412 mM are introduced into a 500 mL flask and stirred vigorously. After 5 minutes, 0.400 mL of solution containing fluorescein is added into the microemulsion with 1 mL of the solution containing the europium complex. Next, 0.200 mL of APTES and 1.5 mL of TEOS (tetraethyl orthosolicate) are also added to the microemulsion.

The polymerization reaction of the silica is completed by the addition of 0.800 mL of NH₄OH after 10 minutes. The microemulsion is left and stirred for 24 hours at ambient temperature.

Next, 190 μL of silane gluconamide (N-(3-triethoxysilylpropyl)gluconamide at 50% in ethanol is added to the microemulsion and stirred at ambient temperature.

After 24 hours, 190 μL of silane gluconamide are again added to the solution and stirring is continued at ambient temperature.

After 24 hours, the microemulsion is destabilized in an ampoule for decanting by addition of a mixture of 250 mL of distilled water and 250 mL of isopropanol. The solution is left to decant for at least 15 minutes and the lower phase containing the particles is recovered.

The recovered colloidal solution is then placed in a tangential filtration system VIVASPIN© at 300 kDa then centrifuged at 4000 r.p.m. until a purification rate greater than 500 is obtained.

The solution thus obtained is then filtered at 0.2 μm and diluted by 5 in DEG (diethyleneglycol). The solution obtained is composed of particles with a mean size 50.25 nm and a polydispersity index 0.091 with very good colloidal stability in a salty aqueous medium (up to 100 g of salts).

Preparation 2. Colloidal Solution of Nanoparticles with a Core of Gold and a Silica Matrix Encapsulating Organic Fluorophores Derived from Rhodamine B and Europium Complexes (DTPA).

The synthesis is similar to that described for the preparation 1 with the difference that the 20 mg of fluorescein isothiocyanate are replaced by 20 mg of rhodamine B isothiocyanate (RBITC). The rest of the synthesis is identical. The solution thus obtained is composed of particles with a mean size of 48 nm and a polydispersity index of 0.072.

Preparation 3. Colloidal Solution of Nanoparticles with a Core of Gold and a Silica Matrix Encapsulating Organic Fluorophores Derived from Fluorescein and Terbium Complexes (DTPA).

The synthesis is similar to that described for the preparation 1 with the difference that the 200 mg of EuCl₃,6H₂O are replaced by 200 mg of TbCl₃,6H₂O. The rest of the synthesis is identical. The solution thus obtained is composed of particles with a mean size of 43 nm and a polydispersity index of 0.069.

Preparation 4. Colloidal Solution of Nanoparticles with a Core of Gold and a Silica Matrix Encapsulating Organic Fluorophores Derived from Rhodamine B and Terbium Complexes (DTPA).

The synthesis is similar to that described for the preparation 1 with the difference that the 20 mg of fluorescein isothiocyanate are replaced by 20 mg of rhodamine B isothiocyanate (RBITC) and that the 200 mg of EuCl₃,6H₂O are replaced by 200 mg of TbCl₃,6H₂O. The rest of the synthesis is identical. The solution thus obtained is composed of particles with a mean size of 46 nm and a polydispersity index of 0.073.

Results

### Example 1

### Detection of a Memory Effect Fluorescent Signal as a Function of the Temperature of the Environment Using Nanoparticles According to the Preparation 1

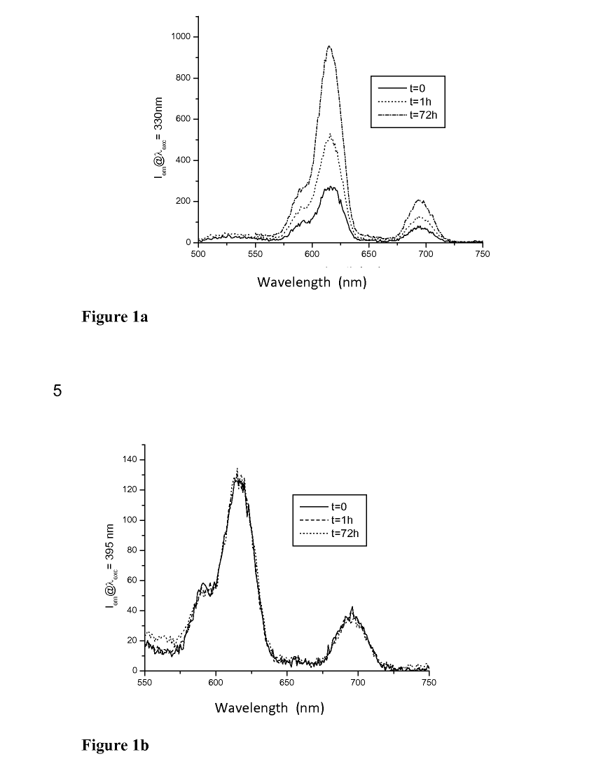

Three samples of 10 mL of colloidal solutions of nanoparticles obtained according to the preparation 1 are heated to 80° C. respectively for 0.1 and 72 hours. The fluorescence study is then carried out and indicates a marked variation in the emission spectra in particular those which are time-resolved. FIG. 1 shows the emission spectra of the three solutions brought to ambient temperature with an excitation wavelength of 330 nm (FIG. 1a) and 395 nm (FIG. 1b). The luminescence curves (FIG. 1a) show a clear increase in the intensity of emission of the particles (peak at 615 nm, specific for europium) in relation to the heat treatment time at 80° C. during the excitation is carried out at 330 nm, whilst at 395 nm no variation is observed (FIG. 1b). The ratio of the emission peaks between these different excitations can therefore serve as probes in order to measure the exposure time of the particles to the temperature of 80° C.

### Example 2

### Detection of a Memory Effect Fluorescent Signal as a Function of the Temperature of the Environment Using Nanoparticles According to the Preparation 3

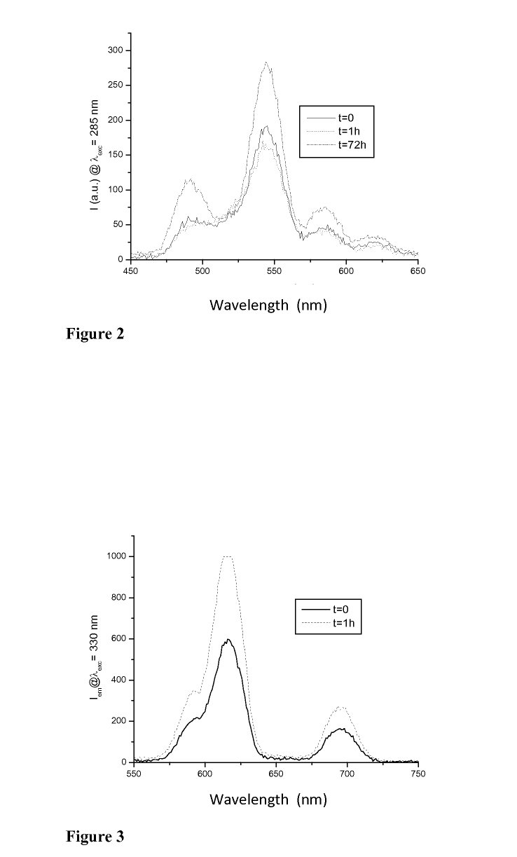

Three samples of 10 mL of colloidal solutions of nanoparticles obtained according to the preparation 3 are heated to 80° C. respectively for 0.1 and 72 hours. The fluorescence study is then carried out and indicates a marked variation in the emission spectra in particular those which are time-resolved. FIG. 2 shows the emission spectra of the three solutions brought to ambient temperature with an excitation wavelength of 285 nm.

The luminescence curves (FIG. 1a) show a clear increase in the intensity of emission of the particles (peak at 550 nm, specific for terbium) in relation to the heat treatment time at 80° C. The intensity of the emission peaks can therefore serve as probes in order to measure the exposure time of the particles to the temperature of 80° C., with an increase in the intensity as a function of the exposure time.

### Example 3

### Detection of a Memory Effect Fluorescent Signal as a Function of the Temperature of the Environment Using Nanoparticles According to the Preparation 2

Two samples of 10 mL of colloidal solutions of nanoparticles obtained according to the preparation 2 are heated to 80° C. respectively for 0.1 and 1 hours. The fluorescence study is then carried out and indicates a marked variation in the emission spectra, in particular those which are time-resolved. FIG. 3 shows the emission spectra of the two solutions brought to ambient temperature with an excitation wavelength of 330 nm.

The luminescence curves show a clear decrease in the intensity of emission of the particles (peak at 550 nm, specific for terbium) in relation to the heat treatment time at 80° C. The intensity of the emission peaks can therefore serve as probes in order to measure the exposure time of the particles to the temperature of 80° C., with a decrease in the intensity as a function of the exposure time.

### Example 4

### Detection of a Memory Effect Fluorescent Signal as a Function of the Temperature of the Environment Using Nanoparticles According to the Preparation 4

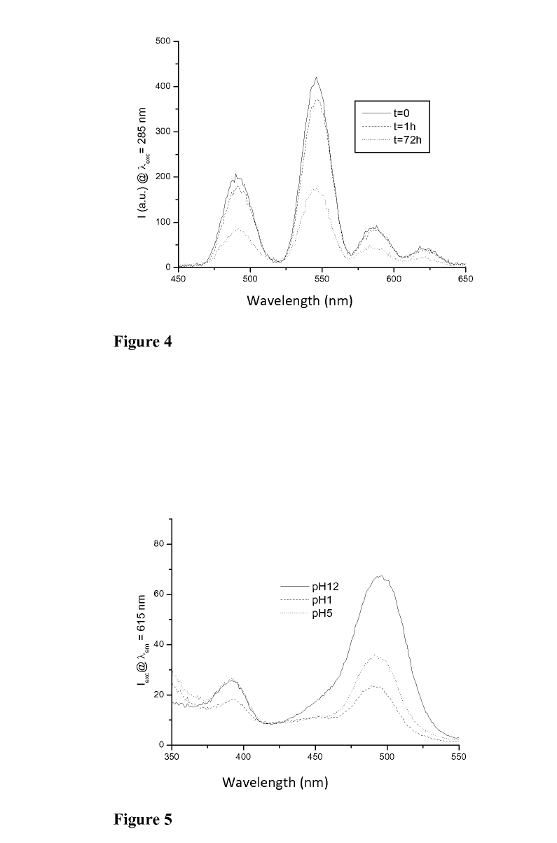

Three samples of 10 mL of colloidal solutions of nanoparticles obtained according to the preparation 4 are heated to 80° C. respectively for 0.1 and 72 hours. The fluorescence study is then carried out and indicates a marked variation in the emission spectra, in particular those which are time-resolved. FIG. 4 shows the emission spectra of the three solutions brought to ambient temperature with an excitation wavelength of 285 nm.

The luminescence curves show a clear decrease in the intensity of emission of the particles (peak at 550 nm, specific for terbium) in relation to the heat treatment time at 80° C. The intensity of the emission peaks can therefore serve as probes in order to measure the exposure time of the particles to the temperature of 80° C., with a decrease in the intensity as a function of the exposure time.

### Example 5

### Detection of a Memory Effect Fluorescent Signal as a Function of the pH of the Environment Using Nanoparticles According to the Preparation 1

Three samples of 1 mL of colloidal solutions of nanoparticles are obtained according to the preparation 1 and dispersed in 10 mL of aqueous solution brought by a soda/hydrochloric acid mixture to a pH of 1.5 and 12 respectively. The fluorescence study is then carried out and indicates a marked variation in the emission spectra, in particular those which are time-resolved. FIG. 5 shows the excitation spectrum at a fixed emission for europium at 615 nm of the three solutions at these different ambient pH values.

The luminescence curves show a clear increase in the excitation spectrum of the particles in relation to the increase in pH. The ratio of the emission (or excitation) peaks can therefore serve as probes in order to measure the pH exposure of the particles.

### Example 6

### Detection of a Memory Effect Fluorescent Signal as a Function of the Nature of the Fluid of the Environment Using Nanoparticles According to the Preparation 1

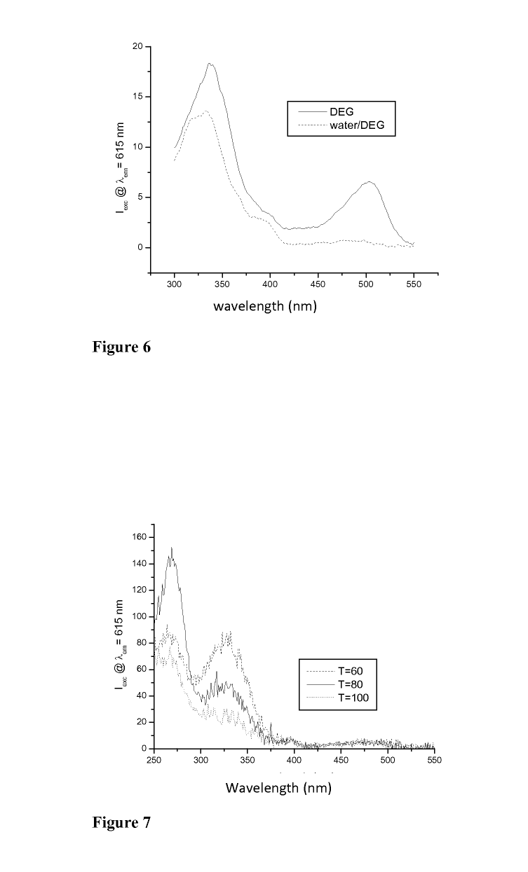

To samples of 5 mL of colloidal solutions of nanoparticles are obtained according to the preparation 1 and dispersed respectively in 5 mL of water and in 5 mL of DEG. The two solutions are then heated to 80° C. for 3 days. The fluorescence study is then carried out and indicates a marked variation in the emission spectra, in particular those which are time-resolved. FIG. 6 shows the excitation spectrum at a fixed emission for europium at 615 mn for the two solutions.

The luminescence curves show a clear deterioration of the excitation spectrum of the particles in relation to the increasing water content. The ratio of the emission (or excitation) peaks can therefore serve as probes in order to measure the rate of exposure of the particles to different water contents.

### Example 7

### Detection of a Memory Effect Fluorescent Signal as a Function of the Variations in Temperature of the Environment Using Nanoparticles According to the Preparation 1

Three samples of 1 mL of colloidal solutions of nanoparticles obtained according to the preparation 1 are mixed with 9 mL of water and heated for 1 hour to 60, 80 and 100° C. The fluorescence study is then carried out and indicates a marked variation in the excitation spectra, in particular those which are time-resolved. FIG. 7 shows the excitation spectra of the three solutions brought to ambient temperature with an emission wavelength of 615 nm.

The luminescence curves show a clear variation in the excitation intensity of the component at 330 nm of the particles in relation to the treatment temperature. The intensity of the emission peaks can therefore serve as probes in order to measure the exposure of the particles, with a decrease in the intensity as a function of the exposure temperature.

The embodiments above are intended to be illustrative and not limiting. Additional embodiments may be within the claims. Although the present invention has been described with reference to particular embodiments, workers skilled in the art will recognize that changes may be made in form and detail without departing from the spirit and scope of the invention.

Various modifications to the invention may be apparent to one of skill in the art upon reading this disclosure. For example, persons of ordinary skill in the relevant art will recognize that the various features described for the different embodiments of the invention can be suitably combined, un-combined, and re-combined with other features, alone, or in different combinations, within the spirit of the invention. Likewise, the various features described above should all be regarded as example embodiments, rather than limitations to the scope or spirit of the invention. Therefore, the above is not contemplated to limit the scope of the present invention.

1-17. (canceled)

18. A method of studying a geological underground area, by diffusion of an injection liquid into said underground area, said method comprising:
injecting an injection liquid into said underground area to be studied, said injection liquid comprising nanoparticles that are capable of forming a stable colloidal suspension in a saline medium, said nanoparticles composing:
a core and, if applicable, a matrix coating the core;
at least one fluorescent entity capable of producing one or more memory effect fluorescence signals such that the fluorescence signal is capable of being irreversibly modified as a result of physiochemical conditions encountered in said underground area; and
a mean diameter between 20 and 200 nm;
collecting said injection liquid which has diffused, at different times following an injection period; and
detection and analyzing said memory effect fluorescent signals emitted by said nanoparticles is a function of time wherein said analysis of the memory effect of fluorescent signals detected make it possible to deduce therefrom information on said physico chemical conditions of said underground geological area studied.

19. The method of claim 18, wherein said injection liquid is collected by an injection well by inverting a flow of said fluid after said injection and diffusion.

20. The method of claim 18, wherein at least a portion of said nanoparticles comprise:
at least one organic fluorophore; and
at least one organometallic fluorophore;
wherein the combination of said organic and organometallic fluorophores being chosen in such a way that said portion of said nanoparticles produce said one or more memory effect-fluorescence signals.

21. The method of claim 20, wherein said organometallic fluorophore is a rare earth ion bound to a complexing agent.

22. The method of claim 21, wherein said organometallic fluorophore is a lanthanide hound to a complexing agent.

23. The method of claim 18, wherein said injection liquid comprises a mixture of nanoparticles, each type of nanoparticles in said mixture being characterized by the emission of one or more specific fluorescent signals, and in that said signals emitted by each type of nanoparticles being detected by multiplex detection means.

24. The method of claim 18, wherein said memory effect fluorescent signal are detected by time-resolved fluorescence.

25. The method of claim 18, wherein a matrix of said nanoparticles comprises radicals R covalently grafted on a basis of silane bonds Si—R on a surface and originating from a group selected from charged hydrophilic compounds, neutral hydrophilic compounds, or one or more hydrophobic compounds.

26-27. (canceled)

28. The method of 18, wherein said injection liquid comprises at least two types of nanoparticles, said at least two types of nanoparticles distinguishable by a hydrophilic/lipophilic balance, a zeta potential, or both said hydrophilic/lipophilic balance and said zeta potential, such that a first portion of said nanoparticles has a fluorescent signal delayed with respect to a second portion of said nanoparticles because of an interaction of said, nanoparticles with said underground area.

29. The method of claim 28, wherein at least a pan of said nanoparticles has said hydrophilic/lipophilic balance adjusted in such a way that said part of said nanoparticles does not interact with a medium of said underground area in which said nanoparticles diffuse, and wherein at least one other part of said nanoparticles has a hydrophilic/lipophilic balance adjusted in such a way that said at least one other pan of said nanoparticles interacts with specific rocks of said underground area.

30. A tracer fluid, said tracer fluid comprising:
nanoparticles that form a stable colloidal suspension in to saline medium, said nanoparticles having a core and, if applicable, a matrix coating the core, at least one organic fluorophore and at least one organometallic fluorophore, wherein the combination of said organic and organometallic fluorophores being chosen in such a way that at least a portion of said nanoparticles produce at least one irreversible memory effect fluorescence signal, said signal being detectable by time-resolved fluorophore, and said nanoparticles having a mean diameter between 20 and 200 nm.

31. The tracer fluid of claim 30, wherein said organometallic fluorophore is a rare earth ion bound to a complexing agent.

32. The tracer fluid of claim 31, wherein said rare earth ion is a lanthanide chosen from Pr, Nd, Sm, Eu, Tb, Dy, Ho, Er, Tm, Yb, and alloys thereof.

33. The tracer fluid of claim 30, wherein at least a portion of said nanoparticles comprises said at least one organic fluorophore chosen from fluorescein or a fluorescien derivative and said at least one organometallic fluorophore being a lanthanide chosen from europium or terbium, said lanthanide being bound to a complexing agent.

34. The tracer fluid of claim 30, wherein at least a portion of said nanoparticles comprises said at least one organic fluorophore chosen from rhodamine or rhodamine derivative and said at least one organometallic fluorophore being a lanthanide chosen from europium or terbium, said lanthanide being bound to a complexing agent.

35. The tracer fluid of 30, wherein said at least one organometallic fluorophore is bound to a complexing agent chosen from Diethylene Triamine PentaAcetic acid (DTPA), a derivative of DTPA, 1,4,7,10-tetraazacyclododecane-1,4,7,10-tetraacetic acid (DOTA), or a derivative of DOTA.

36-37. (canceled)

38. The method of claim 18, wherein said underground area is an oil reservoir.

39. The method of claim 21, wherein said rare earth ion is a lanthanide.

40. The method of claim 25, wherein said charged hydrophilic organic compound has a molar masse below 5000 g/mol.

41. The method of claim 25, said charged hydrophilic organic compound has a molar masse below 450 g/mol.

42. The method of claim 25, wherein said neutral hydrophilic compound is selected among the group consisting of a polyalkylene glycol, Diethylene Triamine PentaAcetic acid (DTPA), dithiolated DTPA (DTDTPA) or a succinic acid, and mixtures thereof.

43. The method of claim 18, wherein at least one part of the nanoparticles have a zeta potential adjusted in such a as that said nanoparticle does not interact with the medium of the underground area in which they diffuse and at least one other part of the nanoparticles has a zeta potential adjusted in such a way as to interact with specific rocks of the underground area.
